(19) United States
(12) Patent Application Publication
(10) Pub. No.: US 2023/0198064 A1
(43) Pub. Date: Jun. 22, 2023

(54) SEALED BATTERY

(71) Applicant: Prime Planet Energy & Solutions, Inc., Tokyo (JP)

(72) Inventors: Kazuki OSHIMA, Himeji-shi (JP); Hiroshi TAKABAYASHI, Koriyama-shi (JP); Naoya TADA, Himeji-shi (JP)

(21) Appl. No.: 18/085,584

(22) Filed: Dec. 21, 2022

(30) Foreign Application Priority Data
Dec. 22, 2021 (JP) 2021-208278

(51) Int. Cl. H01M 50/184; H01M 50/148; H01M 50/102; H01M 50/131; H01M 50/543

(52) U.S. Cl. CPC H01M 50/184; H01M 50/148; H01M 50/102; H01M 50/131; H01M 50/543

(57) ABSTRACT

The herein-disclosed sealed battery includes a battery case, a terminal member (negative electrode external terminal) including an opposed surface opposed to the battery case, and an insulating member (negative side gasket) disposed between the sealing plate and the negative electrode external terminal. Then, the surface of the battery case and/or an opposed surface of the negative electrode external terminal includes a 1st rough surface area on at least a part of a portion contacting with the negative side gasket, and an arithmetic average roughness Sa of the 1st rough surface area is equal to or more than 1 μm. By doing this, it is possible to suppress a liquid leakage of an electrolyte caused by degradation of the negative side gasket.

### CROSS REFERENCE TO RELATED APPLICATIONS

The present application claims the priority based on Japanese Patent Application No. 2021-208278 filed on Dec. 22, 2021, the entire contents of which are incorporated in the present specification by reference.

### BACKGROUND

### 1. Technical Field

The present disclosure relates to the sealed battery.

### 2. Description of the Related Art

A secondary battery, such as a lithium ion secondary battery and a nickel hydrogen battery, is widely used in various fields, for example, a power supply mounted on a vehicle mount or a power supply for a portable terminal. As one example for a structure of this secondary battery, a sealed battery is known.

The sealed battery is constructed by accommodating an electrode body and an electrolyte inside a metal battery case in a sealed state. In addition, this sealed battery includes a terminal structure for electrically connecting the electrode body inside the battery case and an outside equipment (another battery, a motor, or the like). In particular, on the battery case of the sealed battery, a penetration hole called as a terminal attachment hole is formed. A terminal member having an electrically conductive property is inserted into this terminal attachment hole, a portion of the terminal member is connected to the electrode body, and the other portions are exposed to the outside of the battery case. At that time, in a general sealed battery, an insulating member made of resin is arranged between the terminal member and the battery case. By doing this, it is possible to inhibit conduction between the terminal member and the battery case. In addition, this insulating member is attached to the battery case in a state of being pressurized together with the terminal member. By doing this, it is possible to close a gap between the terminal member and the battery case so as to inhibit outflow (liquid leakage) of the electrolyte from the terminal attachment hole.

JP2008-251213 and JP2020-187878 disclose techniques that are related to a terminal structure including a terminal member and an insulating member. For example, a sealed battery described in JP2008-251213 is provided with an electrode outside terminal (terminal member) that includes a flange part formed in a flat plate shape and includes a columnar insertion part inserted into a penetration hole of a battery case. Then, this electrode outside terminal is fixed to a sealing plate of the battery case via an insulating gasket (insulating member). Then, on this flange part of the electrode outside terminal, a ring-shaped first projection part surrounding the columnar insertion part is formed in an incomplete round shape at a surface on which the insulating gasket abuts. On the other hand, on the sealing plate of the battery case, a ring-shaped second projection part surrounding the penetration hole is formed in an incomplete round shape at a surface opposed to the flange part. Then, when the sealed battery is seen through from a direction perpendicular to the sealing plate, the ring-shaped first projection part and the ring-shaped second projection part are formed to make respective projection parts not being overlaid. In accordance with such a configuration, it is possible to enhance a sealing property with the electrode outside terminal and the insulating gasket, and further to inhibit reduction in a sealing property caused by rotation of the electrode outside terminal, and thus it is possible to suitably inhibit the liquid leakage of the electrolyte.

In addition, a sealed battery described in JP2020-187878 includes a metal cover (battery case), a polymer molded body (insulating member), and an electrode (terminal member). Then, on a back surface of the metal cover of this sealed battery, a ring-shaped first projection part is provided to be formed in a convex shape toward a basal part of the polymer molded body. In addition, on a front surface of the electrode, a ring-shaped second projection part is provided to be formed in a convex shape toward the basal part of the polymer molded body. Then, in this sealed battery described by this JP2020-187878, the size of each of the projection parts is set to satisfy a predetermined condition. By doing this, it is possible to enhance a durability of the sealing structure of this battery, and to suppress the liquid leakage of the electrolyte for a long period.

### SUMMARY

As described above, the insulating member is attached to the terminal attachment hole in a state of being disposed between the battery case and the terminal member and being pressurized. By the insulating member rebounding from this pressure, it is possible to close the slight gap between the terminal member and the battery case so as to inhibit the liquid leakage of the electrolyte. However, if the insulating member is degradated due to exposure to a high temperature environment or due to aging degradation, the insulating member might be deformed by the pressure from the battery case and the terminal member. In that case, there is a fear that a gap is generated between respective members (terminal member, insulating member, and battery case) configuring the terminal structure so as to cause the liquid leakage.

The present disclosure has been made in view of the above-described circumstances, and the main object is to provide a sealed battery that can suppress the liquid leakage of the electrolyte caused by degradation of the insulating member.

In order to deal with the object, a herein-disclosed sealed battery is provided.

A herein-disclosed sealed battery includes a battery case that includes a terminal attachment hole and is configured to accommodate an electrode body, a terminal member that is attached to a terminal attachment hole and includes an opposed surface being opposed to a surface of a battery case at a periphery of a terminal attachment hole, and an insulating member that is made of resin and is disposed between a battery case and a terminal member. Then, a surface of a battery case and/or an opposed surface of a terminal member includes a rough surface area on at least a part of a portion contacting with an insulating member, and an arithmetic average roughness Sa of a rough surface area is equal to or more than 1 μm.

In the herein-disclosed sealed battery, a terminal member is attached to a terminal attachment hole, and an insulating member is disposed between a battery case and a terminal member. When the insulating member is degradated in the sealed battery including the configuration as described above, the insulating member may be deformed to an outside in a diameter direction with respect to the terminal attachment hole treated as a center. For this circumstance, in the herein-disclosed sealed battery, the rough surface area (area whose arithmetic average roughness Sa is equal to or more than 1 μm) is formed on at least one among the surface of the battery case and the opposed surface of the terminal member. By doing this, a friction resistance between the battery case and the insulating member (and/or a friction resistance between the terminal member and the insulating member) is increased, and thus it is possible to regulate deformation of the insulating member to an outside in a diameter direction. By doing this, it is possible to inhibit generation of a gap between respective members configuring the terminal structure, and thus it is possible to suppress the liquid leakage of the electrolyte caused by degradation of the insulating member.

Incidentally, the ring-shaped projection part formed by a conventional technique (JP2008-251213, JP2020-187878, or the like) can be molded by a pressing process, or the like. The pressing process for molding this projection part includes a difficulty in a point about what portion of a sheet metal should be processed to obtain a desired shape. Therefore, it is very difficult to form a projection part having a desired shape with respect to the very small member. For this circumstance, the rough surface area formed on the herein-disclosed sealed battery has a higher degree of freedom for forming in comparison with a conventional ring-shaped projection, and thus can be suitably applied to a sealing structure of the sealed battery tending to be refined more than a conventional one, which is a suitable effect that cannot be observed in the conventional technique.

In a first aspect of the herein-disclosed sealed battery, a terminal member includes an outside terminal part including a shaft part that is inserted into a terminal attachment hole, and a flange part that is formed in a plate shape and extends from a shaft part along an outer surface of a battery case at an outside of a battery case. An insulating member includes a gasket that is disposed between an outer surface of a battery case and an opposed surface of the flange part. An outer surface of a battery case and/or an opposed surface of a flange part includes a rough surface area on at least a part of a portion contacting with a gasket.

As one among the insulating members contained in the terminal structure, it is possible to use a gasket disposed between the outside terminal part and the outer surface of the battery case. In order to regulate the deformation of this gasket, it is preferable that the rough surface area is formed on the outer surface of the battery case and/or the opposed surface of the flange part of the outside terminal part. By doing this, it is possible to suitably suppress the liquid leakage caused by the degradated deformation of the gasket.

In the first aspect, it is preferable that a terminal member further includes an inside plate-shaped part connected to an outside terminal part inside a battery case and extending along an inner surface of a battery case. An insulating member includes an insulating plate disposed between an inner surface of a battery case and an opposed surface of an inside plate-shaped part. An inner surface of a battery case and/or an opposed surface of an inside plate-shaped part includes a rough surface area on at least a part of a portion contacting with an insulating plate.

The terminal member for forming the terminal structure might include a plate-shaped conductive member (inside plate-shaped part) extending inside the battery case along the inner surface of the batter case. In that situation, the insulating plate is arranged between the battery case and the inside plate-shaped part. In order to regulate deformation of this insulating plate, it is preferable that the rough surface area is formed on the inner surface of the battery case and/or the opposed surface of the inside plate-shaped part. By doing this, it is possible to suitably suppress the liquid leakage caused by the degradated deformation of the insulating plate. Then, in the present aspect, the rough surface area is formed on both metal members at the outside and at the inside of the battery case, and thus it is possible in particular to suitably suppress the liquid leakage caused by the degradation of the insulating part.

Incidentally, in the above described aspect, the inside plate-shaped part is a long plate-shaped member arranged along an inner surface of a battery case and is a plate-shaped electrical collector part whose one end part is connected to an outside terminal part and whose another end part is connected to an electrode body.

As one example of the inside plate-shaped part, it is possible to use the electrical collector part connected to the collector tab of the electrode body. In the terminal structure including the above-described electrical collector part, it is preferable that the rough surface area is formed on the inner surface of the battery case and/or the opposed surface of the electrical collector part. By doing this, it is possible to suitably suppress the liquid leakage caused by the degradated deformation of the insulating plate.

In one aspect of the herein-disclosed sealed battery, a terminal member includes a current interrupt device that is connected to an outside terminal part inside a battery case and is configured to interrupt an electrically conductive passage when an internal pressure of a battery case exceeds a predetermined pressure, and an electrical collector part that is connected between a current interrupt device and an electrode body. A current interrupt device includes a sealing tab including a base part that is connected to an outside terminal part inside the battery case and is arranged along an inner surface of a battery case, and including a ring-shaped protruding part that protrudes from a base part to an electrode body, and an inversion plate that is connected to a protruding part of a sealing tab, is connected to an electrical collector part, and is configured to be deformed and spaced away from an electrical collector part when an internal pressure of a battery case rises to a value equal to or more than a predetermined value. The inside plate-shaped part is a base part of a sealing tab.

As another example of the above-described inside plate-shaped part, it is possible to use the sealing tab of the current interrupt device. In particular, regarding the terminal member including the current interrupt device, the current interrupt device is arranged between the outside terminal part and the electrical collector part, and thus it implements inhibiting the electrical collector part and the battery case from being directly opposed. Then, in the terminal structure including the configuration as described above, it is possible to implement “inside plate-shaped part” in which the sealing tab of the current interrupt device is arranged along the battery case. Thus, by forming the rough surface area on the inner surface of the battery case and/or the opposed surface of the base part of the sealing tab, it is possible to suitably suppress the liquid leakage caused by the degradated deformation of the insulating plate.

In a second aspect of the herein-disclosed sealed battery, a terminal member includes an outside terminal part whose one part is exposed to an outside of a battery case, and an inside plate-shaped part that is connected inside a battery case to an outside terminal part and extends along an inner surface of a battery case. An insulating member includes an insulating plate disposed between an inner surface of a battery case and an opposed surface of an inside plate-shaped part. An inner surface of a battery case and/or an opposed surface of an inside plate-shaped part includes a rough surface area on at least a part of a portion contacting with an insulating plate.

As shown in the present aspect, even if the rough surface area is formed only on the metal member inside the battery case, it is possible to properly suppress the liquid leakage caused by the degradated deformation of the insulating plate.

In one aspect of the herein-disclosed sealed battery, a projection part protruding toward an insulating member and surrounding a terminal attachment hole in a plane view is formed on a surface of a battery case and/or an opposed surface of a terminal member.

The above described projection part surrounding the terminal attachment hole can interrupt the deformation of the insulating member toward the outside in the diameter direction with the terminal attachment hole treated as the center, and thus it is possible to further suitably suppress the liquid leakage caused by the degradated deformation of the insulating member.

In one aspect of the herein-disclosed sealed battery, a surface of a battery case and/or an opposed surface of a terminal member includes a rough surface area on a part equal to or more than 5% of a portion contacting with an insulating member.

By securing the rough surface area whose size is equal to or more than a predetermined value as described above, the friction resistance between the battery case and the insulating member (and/or a friction resistance between the terminal member and the insulating member) is further increased, and thus it is possible to suitably suppress the liquid leakage caused by the degradated deformation of the insulating member.

In one aspect of the herein-disclosed sealed battery, an arithmetic average roughness Sa of a rough surface area is equal to or less than 100 μm.

From a perspective of regulating the degradated deformation of the insulating member, the upper limit of the arithmetic average roughness Sa of the rough surface area is not particularly restricted. However, from a perspective of simplifying the process for forming the rough surface area so as to enhance the manufacture efficiency, it is preferable that the arithmetic average roughness Sa of the rough surface area is equal to or less than 100 μm.

### BRIEF DESCRIPTION OF THE DRAWINGS

FIG. 1 is a cross section view that schematically shows a sealed battery in accordance with one embodiment.

FIG. 2 is a disassembled perspective view of the sealed battery in accordance with one embodiment.

FIG. 3 is an enlarged cross section view of a negative electrode terminal assembly on the sealed battery in accordance with one embodiment.

FIG. 4 is an enlarged cross section view of a positive electrode terminal assembly on the sealed battery in accordance with one embodiment.

### DETAILED DESCRIPTION

Below, an embodiment of a herein-disclosed technique will be explained while referring to drawings. Incidentally, the matters other than matters particularly mentioned in this specification and required for practicing the present disclosure (for example, manufacture process, or the like) can be grasped as design matters of those skilled in the art based on the related art in the present field. The herein-disclosed technique can be executed based on the contents disclosed in the present specification, and the technical common sense in the present field. Incidentally, a wording “A to B” representing a range in the present specification semantically covers not only a meaning of being “equal to or more than A and equal to or less than B”, but also meanings of “preferably more than A” and “preferably less than B”.

### Embodiment 1

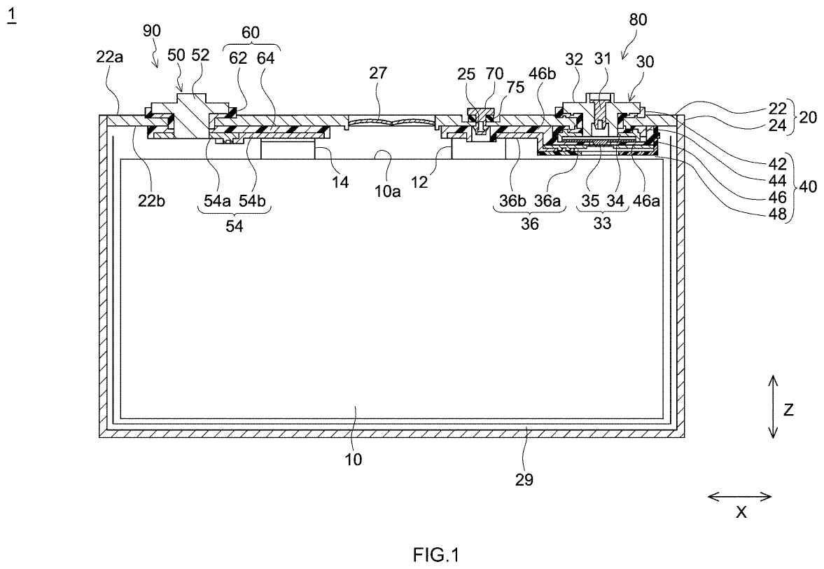

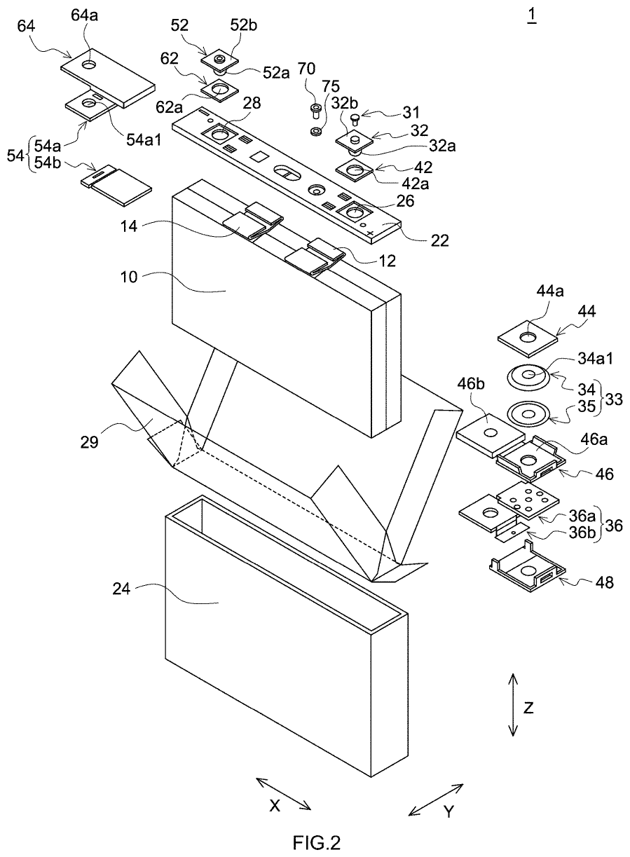

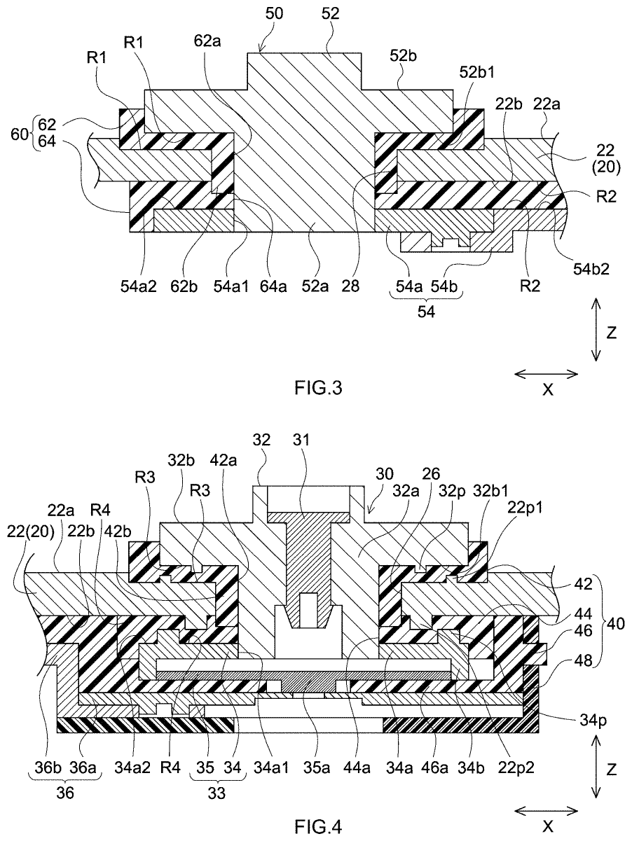

FIG. 1 is a cross section view that schematically shows a sealed battery in accordance with the present embodiment. FIG. 2 is a disassembled perspective view of the sealed battery in accordance with the present embodiment. FIG. 3 is an enlarged cross section view of a negative electrode terminal assembly on the sealed battery in accordance with the present embodiment. FIG. 4 is an enlarged cross section view of a positive electrode terminal assembly on the sealed battery in accordance with the present embodiment. Incidentally, in each drawing, a reference sign X represents “width direction (of the sealed battery)”, a reference sign Y represents “depth direction”, and a reference sign Z represents “height direction”. However, these are directions defined for convenience sake of explanation, and thus it is not intended to restrict a disposed form of the sealed battery at a manufacturing time or at a use time.

As shown in FIG. 1 and FIG. 2, the sealed battery 1 in accordance with the present embodiment includes an electrode body 10, and a battery case 20 configured to accommodate the electrode body 10. In addition, as the illustration is omitted, the battery case 20 at the inside accommodates an electrolyte, in addition to the electrode body 10. Below, each configuration of the sealed battery 1 will be described.

1. Electrode Body

The electrode body 10 is a power generating element accommodated inside the battery case 20. The electrode body 10 in the present embodiment is accommodated in the battery case 20 while being covered by an insulating film 29 made of resin. By doing this, it is possible to inhibit conduction between the electrode body 10 and the battery case 20. In addition, although the detailed illustration is omitted, the electrode body 10 in the present embodiment is a laminate electrode body in which plural positive electrode sheets and plural negative electrode sheets are laminated via separators having insulating properties. The positive electrode sheet includes a positive electrode collector foil being an electrically conductive metal foil, and includes a positive electrode composite material layer provided on a surface of the positive electrode collector foil. In addition, the negative electrode sheet includes a negative electrode collector foil being an electrically conductive metal foil, and includes a negative electrode composite material layer provided on a surface of the negative electrode collector foil. Incidentally, regarding materials of configuration parts (positive electrode sheet, negative electrode sheet, separator, or the like) of the electrode body 10, materials similar to ones of a conventionally known general secondary battery can be used without particular restriction, the materials do not characterize the herein-disclosed technique use, and thus the detailed explanation is omitted.

In addition, the electrode body 10 in the present embodiment includes a pair of collector tabs protruding upwardly in a height direction Z from an upper surface 10a of the electrode body 10. In particular, each of plural positive electrode sheets included in the electrode body 10 includes a positive electrode exposed part, on which the positive electrode collector foil is exposed as the positive electrode composite material layer is not provided. This positive electrode exposed part protrudes toward the height direction from a part of the upper surface of the positive electrode sheet. The collector tab (positive electrode collector tab 12) at the positive electrode side is formed by collecting plural foils of the positive electrode exposed parts. On the other hand, each of plural negative electrode sheets included in the electrode body 10 also includes a negative electrode exposed part, on which the negative electrode collector foil is exposed as with the negative electrode composite material layer is not provided. This negative electrode exposed part protrudes toward the height direction from a part of the upper surface of the negative electrode sheet, so as to avoid being overlaid on the positive electrode exposed part. Then, the collector tab (negative electrode collector tab 14) at the negative electrode side is formed by collecting plural foils of the negative electrode exposed parts.

2. Electrolyte

The electrolyte is a liquid electrolyte permeated to an inside (typically, between the positive electrode sheet and the negative electrode sheet) of the electrode body 10. Regarding the sealed battery 1 in accordance with the present embodiment, charge carriers (for example, lithium ions) move via the electrolyte between the positive electrode sheet and the negative electrode sheet so as to perform charging and discharging. Incidentally, regarding a material of the electrolyte, a material similar to one used in a conventionally known secondary battery can be used without particular restriction, the material does not characterize the herein-disclosed technique, and thus the explanation is omitted.

Incidentally, it is not required for the electrolyte accommodated in the battery case 20 that all of the electrolyte is permeated inside the electrode body 10. For example, a part of the electrolyte might exist as an excess electrolyte at an outside (between the electrode body 10 and the battery case 20) of the electrode body 10. The sealed battery 1 including this excess electrolyte can supply an electrolyte when the electrode body 10 run shortage of the electrolyte at the inside, and thus it is possible to suppress increase in the inside resistance caused by the liquid shortage. On the other hand, the excess electrolyte freely moves inside the battery case 20, and therefore it can cause the liquid leakage of the electrolyte from the terminal structure. For this circumstance, the herein-disclosed technique can suppress reduction in the sealing property of the terminal structure, and thus it is possible to suitably suppress the liquid leakage of the electrolyte even when the excess electrolyte exists. In other words, the herein-disclosed technique can be suitably applied in particular to the sealed battery including the excess electrolyte inside the battery case.

3. Battery Case

The battery case 20 is a metal container configured to accommodate the electrode body 10. The battery case 20 in the present embodiment includes a case body 24 being a bottomed box-shaped member whose upper surface is opened, and includes a sealing plate 22 being a plate-shaped member configured to cover the upper surface opening of the case body 24. Then, it is preferable that these configuration members of the battery case 20 each has a predetermined rigidity and is configured with a lightweight material. For the material as described above, it is possible to use aluminum, aluminum alloy, or the like.

As shown in FIG. 2, a positive insertion hole 26 is formed at one (right side in FIG. 2) of end parts in a width direction X of the sealing plate 22. In addition, a negative insertion hole 28 is formed the other one (left side in FIG. 2) of the end parts of the sealing plate 22. Then, a positive electrode terminal assembly 80 is attached to the positive insertion hole 26, and a negative electrode terminal assembly 90 is attached to the negative insertion hole 28 (see FIG. 1). Incidentally, a particular structure of each terminal structure will be explained later in details.

In addition, a liquid injection hole 25 is formed on the sealing plate 22 in the present embodiment. The liquid injection hole 25 is opened at a manufacturing step of the sealed battery 1, and the electrolyte is injected to an inside of the battery case 20 through the liquid injection hole 25. Then, on the sealed battery 1 after being manufactured, the liquid injection hole 25 is sealed by a sealing plug 70. In addition, between the sealing plug 70 and an outer surface 22a of the sealing plate 22, a sealing member 75 made of resin is arranged. By doing this, it is possible to inhibit the liquid leakage from the liquid injection hole 25.

In addition, at a central part of the sealing plate 22 in the width direction X, a gas exhaust valve 27 is formed. The gas exhaust valve 27 is a thin-walled part whose thickness is smaller than the other portions of the battery case 20 (sealing plate 22). This gas exhaust valve 27 is configured to be broken when an internal pressure of the battery case 20 becomes equal to or more than a predetermined value, so as to exhaust the gas generated inside the battery case 20 to the outside. Incidentally, the operating pressure (broken pressure) of the gas exhaust valve 27 is set to be a pressure higher than an operating pressure of a current interrupt device 33 described later.

4. Terminal Structure

As described above, in the sealed battery 1 in accordance with the present embodiment, the positive electrode terminal assembly 80 and the negative electrode terminal assembly 90 are attached to the sealing plate 22 of the battery case 20. The term “terminal structure” in the present specification means a structure for forming an electrically conductive passage from the electrode body to the outside of the battery case, without conduction between the battery case and the electrode body. The terminal structure described above can be constructed by attaching a metal terminal member and a resin-made insulating member to the battery case (sealing plate). Incidentally, in the present specification, a terminal structure connected to the positive electrode of the electrode body is referred to as “positive electrode terminal assembly”, and a terminal structure connected to the negative electrode is referred to as “negative electrode terminal assembly”. In addition, a terminal member constructing the positive electrode terminal assembly is referred to as “positive electrode terminal member” and an insulating member constructing the positive electrode terminal assembly is referred to as “positive side insulating member”. Furthermore, a terminal member constructing the negative electrode terminal assembly is referred to as “negative electrode terminal member”, and an insulating member constructing the negative electrode terminal assembly is referred to as “negative side insulating member”.

Here, the herein-disclosed sealed battery has a feature of including a rough surface area on at least a part of a portion contacting with the insulating member of a surface of the battery case and/or an opposed surface of the terminal member. By doing this, it is possible to suitably suppress the liquid leakage caused by degradated deformation of the insulating member. On the sealed battery 1 in accordance with the present embodiment, this rough surface area is formed at 4 points. Below, while referring to FIG. 3 to FIG. 4, each of rough surface areas at these 4 points (1st rough surface area R1 to 4th rough surface area R4) will be described.

(1) 1st Rough Surface Area

The 1st rough surface area R1 is a rough surface area formed on the negative electrode terminal member 50 at the outside of the battery case 20. Below, while referring to a configuration of the negative electrode terminal assembly 90 outside the battery case 20, the 1st rough surface area R1 will be described.

As shown in FIG. 3, the negative electrode terminal member 50 constructing the negative electrode terminal assembly 90 includes a negative electrode external terminal 52 whose one part is exposed to the outside of the battery case 20. This negative electrode external terminal 52 includes a shaft part 52a that is inserted into the negative insertion hole 28, and includes a flange part 52b that is formed in a plate shape and extends along an outer surface (outer surface 22a of the sealing plate 22) of the battery case from the shaft part 52a at the outside of the battery case 20. As shown in FIG. 2, the shaft part 52a is a member formed in a column shape and is inserted into the negative insertion hole 28 formed in a circular shape. On the other hand, the flange part 52b is a plate-shaped member whose flat surface is rectangular. As shown in FIG. 3, a lower surface of this flange part 52b is an opposed surface 52b1 that is opposed to an outer surface 22a of the sealing plate 22.

Next, the negative side insulating member 60 constructing the negative electrode terminal assembly 90 includes a negative side gasket 62 disposed between the outer surface 22a of the sealing plate 22 and the opposed surface 52b1 of the flange part 52b. This negative side gasket 62 is a plate-shaped member whose flat surface is rectangular and on which an opening part 62a formed in a circular shape is formed at the center (see FIG. 2). In addition, on a bottom surface of the negative side gasket 62, a ring-shaped projection 62b is formed that protrudes downward in the height direction Z from an outer circumferential edge part of the opening part 62a. This ring-shaped projection 62b is inserted into the negative insertion hole 28 of the sealing plate 22, and is disposed between the shaft part 52a of the negative electrode external terminal 52 and the battery case 20 (sealing plate 22). As described above, the negative side gasket 62 is disposed between the negative electrode external terminal 52 and the sealing plate 22 so as to inhibit conduction between them. In addition, the negative side gasket 62 is pressurized between the negative electrode external terminal 52 and the sealing plate 22. By doing this, the gap between the negative electrode external terminal 52 and the sealing plate 22 is closed so as to inhibit the liquid leakage of the electrolyte. Incidentally, regarding the attachment of this kind of terminal structure, the pressure applied on the resin member (here, negative side gasket 62) can be set within a range of 10 N to 6000 N (for example, 3000 N).

Here, when the negative side gasket 62 is degradated by exposure to the high temperature environment or the like, the negative side gasket 62 tends to be deformed to an outside in the diameter direction with the negative insertion hole 28 (shaft part 52a of the negative electrode external terminal 52) treated as the center because of the pressure received from the negative electrode external terminal 52 and the sealing plate 22. However, regarding the sealed battery 1 in accordance with the present embodiment, the 1st rough surface area R1 is formed on each among the outer surface 22a of the sealing plate 22 and the opposed surface 52b1 of the flange part 52b. By doing this, a friction resistance between the sealing plate 22 and the negative side gasket 62 and a friction resistance between the flange part 52b and the negative side gasket 62 become larger, and thus it is possible to regulate the deformation of the negative side gasket 62 toward the outside in the diameter direction. Therefore, according to the present embodiment, it is possible to suitably suppress the liquid leakage caused by degradated deformation of the negative side gasket 62.

Incidentally, the term “rough surface area” in the present specification means an area whose surface has an arithmetic average roughness Sa being equal to or more than 1 μm. It is confirmed with an experiment that, by making a metal member including the rough surface area as described above contact with an insulating member made of resin, the degradated deformation of the insulating member can be regulated. Incidentally, from a perspective of suitably regulating the degradated deformation of the insulating member, the arithmetic average roughness Sa on the rough surface area is preferably equal to or more than 1.2 μm, further preferably equal to or more than 1.4 μm, furthermore preferably equal to or more than 1.6 μm, or in particular preferably equal to or more than 1.8 μm. On the other hand, from a perspective of regulating the degradated deformation of the insulating member, the upper limit of the arithmetic average roughness Sa of the rough surface area is not particularly restricted. However, from a perspective of simplifying a process for forming the rough surface area so as to enhance manufacture efficiency, the arithmetic average roughness Sa of the rough surface area is preferably equal to or less than 100 μm, further preferably equal to or less than 50 μm, furthermore preferably equal to or less than 25 μm, or in particular preferably equal to or less than 10 μm. Incidentally, the term “arithmetic average roughness Sa” in the present specification means an arithmetic average roughness Sa defined by ISO25178.

In addition, a maximum height Sz of the rough surface area is preferably equal to or more than 15 μm, further preferably equal to or more than 20 m, or in particular preferably equal to or more than 25 μm. By forming the rough surface area having a larger maximum height Sz on a surface of the metal member contacting with the insulating member, it is possible to furthermore suitably regulate the degradated deformation of the insulating member. On the other hand, from a perspective of simplifying a process of forming the rough surface area so as to enhance manufacture efficiency, the maximum height Sz of the rough surface area is preferably equal to or less than 200 μm, further preferably equal to or less than 150 μm, furthermore preferably equal to or less than 100 μm, or in particular preferably equal to or less than 50 μm.

In addition, the process of forming the rough surface area on the surface of the metal member does not restrict the herein-disclosed technique, and therefore a conventionally known roughening process can be used without particular restriction. For the roughening process as described above, it is possible to use a plating process, an edging process, an electrolytic polishing, a chemical polishing, a blast processing, a laser processing, or the like. In addition, it is preferable that the rough surface area is formed to be equal to or more than 5% of a surface contacting with the insulating member (further suitably equal to or more than 20%, or furthermore suitably equal to or more than 50%). By doing this, it is possible to suitably regulate the degradated deformation of the insulating member. In addition, the upper limit of the size of the rough surface area, which is not particularly restricted, might be 100% of the contact surface with the insulating member, might be equal to or less than 90%, might be equal to or less than 80%, or might be equal to or less than 70%.

In addition, a material of the resin member used in the present embodiment is not particularly restricted, and thus a material used in a conventionally known sealed battery can be used without particular restriction. As one example of the material of this resin member, it is possible to use polypropylene (PP), ethylene fluoride (PFE), polyphenylene sulfide (PPS), tetrafluoroethylene-hexafluoropropylene copolymer (FEP), tetrafluoroethylene-ethylene copolymer (ETFE), polyether ether ketone (PEEK), or the like. These resin members tend to be deformed by degradation with comparative ease, but it is possible to suitably regulate the degradated deformation by making each of these resin members contact with a rough surface area whose arithmetic average roughness Sa is equal to or more than 1 μm.

Incidentally, in the present embodiment, the 1st rough surface area R1 is formed on both of the outer surface 22a of the sealing plate 22 and the opposed surface 52b1 of the flange part 52b. However, the 1st rough surface area R1 might be formed on any one of the outer surface 22a of the sealing plate 22 and the opposed surface 52b1 of the flange part 52b. It has been confirmed with experiments that the degradated deformation of the insulating member can be properly regulated even when the rough surface area is formed on only any one of the metal members contacting with the insulating member.

(2) 2nd Rough Surface Area

The 2nd rough surface area R2 is a rough surface area formed on the negative electrode terminal member 50 at an inside of the battery case 20. Below, while referring to a configuration of the negative electrode terminal assembly 90 at the inside of the battery case 20, the 2nd rough surface area R2 will be described.

As shown in FIG. 3, the negative electrode terminal member 50 in the present embodiment includes a negative electrode current collector 54 that is an inside plate-shaped part. The term “inside plate-shaped part” in the present specification means a concept semantically covering a plate-shaped metal member that is connected to an outside terminal part inside the battery case and extends along an inner surface of the battery case. The negative electrode current collector 54 in the present embodiment includes a first negative electrode current collector 54a (see FIG. 3) that is connected to the negative electrode external terminal 52 inside the battery case 20, and includes a second negative electrode current collector 54b (see FIG. 1) that extends along an inner surface (inner surface 22b of the sealing plate 22) of the battery case. In particular, as shown in FIG. 2 and FIG. 3, the first negative electrode current collector 54a is a plate-shaped member whose flat surface is rectangular and on which an opening part 54al formed in a circular shape is formed at the central part. A shaft part 52a of the negative electrode external terminal 52 is inserted into this opening part 54al. On the other hand, as shown in FIG. 1 and FIG. 2, the second negative electrode current collector 54b is a long plate-shaped conductive member that extends in the width direction X. One end part (left side in FIG. 1) in the width direction X of the second negative electrode current collector 54b is connected to the first negative electrode current collector 54a. On the other hand, the other end part (right side in FIG. 1) of the second negative electrode current collector 54b is connected to the negative electrode collector tab 14 of the electrode body 10.

As shown in FIG. 2, the negative side insulating member 60 includes a negative side insulating plate 64, at an inside of the battery case 20. This negative side insulating plate 64 is a plate-shaped resin-made member that is disposed between the inner surface 22b of the sealing plate 22 and the opposed surfaces 54a2, 54b2 of the inside plate-shaped part (negative electrode current collector 54). By doing this, it is possible to inhibit conduction between the sealing plate 22 and the negative electrode current collector 54. In addition, at one end part (right side in FIG. 2) in the width direction X of the negative side insulating plate 64, an opening part 64a formed in a circular shape is formed. Then, as shown in FIG. 3, the shaft part 52a of the negative electrode external terminal 52 is inserted into the opening part 64a of the negative side insulating plate 64. In addition, the negative side insulating plate 64 is pressurized between the negative electrode current collector 54 and the sealing plate 22. By doing this, it is possible to close the gap between the negative electrode external terminal 52 and the negative side insulating plate 64 so as to inhibit the liquid leakage of the electrolyte.

Here, regarding the sealed battery 1 in accordance with the present embodiment, the 2nd rough surface area R2 is formed on each among the inner surface 22b of the sealing plate 22 and the opposed surfaces 54a2, 54b2 of the negative electrode current collector 54. By doing this, the friction resistance between the sealing plate 22 and the negative side insulating plate 64 and the friction resistance between the negative electrode current collector 54 and the negative side insulating plate 64 are increased, and thus it is possible to regulate deformation of the negative side insulating plate 64 toward an outside in a diameter direction. Thus, according to the present embodiment, it is possible to suitably suppress the liquid leakage caused by the degradated deformation of the negative side insulating plate 64.

Incidentally, a suitable surface roughness and suitable size of the 2nd rough surface area R2 are similar to those of the 1st rough surface area R1 described above, and thus the overlapping expiation is omitted. In addition, similarly to the 1st rough surface area R1, it is also enough for the 2nd rough surface area R2 to be formed on at least one of metal members contacting with the insulating member. In other words, it might be sufficient that a surface on which the 2nd rough surface area R2 is formed is any one among the inner surface 22b of the sealing plate 22 and the opposed surfaces 54a2, 54b2 of the negative electrode current collector 54. In addition, when the 2nd rough surface area R2 is formed on the opposed surface of the negative electrode current collector 54, the 2nd rough surface area R2 might be formed on only any one among the opposed surface 54a2 of the first negative electrode current collector 54a and the opposed surface 54b2 of the second negative electrode current collector 54b. Even in that situation, it is possible to sufficiently regulate the degradated deformation of the negative side insulating plate 64.

(3) 3rd Rough Surface Area

The 3rd rough surface area R3 is a rough surface area formed on the positive electrode terminal member 30 at the outside of the battery case 20. Below, while referring to a configuration of the positive electrode terminal assembly 80 at the outside of the battery case 20, the 3rd rough surface area R3 will be described.

As shown in FIG. 4, the positive electrode terminal member 30 constructing the positive electrode terminal assembly 80 includes a positive electrode external terminal 32 whose one part is expose to the outside of the battery case 20. This positive electrode external terminal 32 includes a shaft part 32a that is inserted into the positive insertion hole 26, and a flange part 32b that is formed in a plate shape and extends along the outer surface (outer surface 22a of the sealing plate 22) of the battery case from the shaft part 32a at the outside of the battery case 20. Incidentally, regarding the positive electrode external terminal 32, a cavity is formed inside the shaft part 32a. To the inside cavity of the shaft part 32a, a terminal plug 31 is attached. This terminal plug 31 is moved upward in the height direction Z by the internal pressure of the battery case 20 when a later-described current interrupt device 33 is operated. By doing this, visual recognition from the outside about whether the current interrupt device 33 is operated or not can be implemented. On the other hand, the flange part 32b is a plate-shaped member whose flat surface is rectangular. As shown in FIG. 3, even in the positive electrode terminal member 30, a lower surface of the flange part 32b becomes an opposed surface 32b1 opposed to the outer surface 22a of the sealing plate 22.

On the other hand, a positive side insulating member 40 constructing the positive electrode terminal assembly 80 includes a positive side gasket 42 disposed between the outer surface 22a of the sealing plate 22 and the opposed surface 32b1 of the flange part 32b. This positive side gasket 42 includes configurations similar to those of the above described negative side gasket 62. In other words, the positive side gasket 42 is also a plate-shaped member whose flat surface is rectangular and on which an opening part 42a formed in a circular shape is formed at the central part (see FIG. 2). In addition, as shown in FIG. 4, a ring-shaped projection 42b protruding downward in the height direction Z from an outer circumferential edge part of the opening part 42a is formed on the bottom surface of the positive side gasket 42, too. This ring-shaped projection 42b is inserted into the positive insertion hole 26 and is disposed between the shaft part 32a of the positive electrode external terminal 32 and the battery case 20 (sealing plate 22). As described above, the positive side gasket 42 is disposed between the positive electrode external terminal 32 and the sealing plate 22 so as to inhibit the conduction between them. In addition, the positive side gasket 42 is pressurized between the positive electrode external terminal 32 and the sealing plate 22. By doing this, it is possible to close the gap between the positive electrode external terminal 32 and the sealing plate 22 so as to inhibit the liquid leakage of the electrolyte.

Here, regarding the sealed battery 1 in accordance with the present embodiment, the 3rd rough surface area R3 is formed on each among the outer surface 22a of the sealing plate 22 and the opposed surface 32b1 of the flange part 32b. By doing this, each of a friction resistance between the sealing plate 22 and the positive side gasket 42 and a friction resistance between the flange part 32b and the positive side gasket 42 becomes larger, and thus it is possible to regulate the deformation of the positive side gasket 42 toward the outside in the diameter direction. Thus, according to the present embodiment, it is possible to suitably suppress the liquid leakage caused by the degradated deformation of the positive side gasket 42.

Incidentally, a suitable surface roughness and suitable size of the 3rd rough surface area R3 are similar to those of the 1st rough surface area R1 and those of the 2nd rough surface area R2, and thus the overlapping explanation is omitted. In addition, similarly to the 1st rough surface area R1 and the 2nd rough surface area R2, it is also enough for the 3rd rough surface area R3 to be formed on at least one of metal members contacting with the insulating member. In other words, it might be sufficient that a surface on which the 3rd rough surface area R3 is formed is any one among the outer surface 22a of the sealing plate 22 and the opposed surface 32b1 of the flange part 32b. Even in that situation, it is possible to sufficiently regulate the degradated deformation of the positive side gasket 42.

In addition, regarding the positive electrode terminal assembly 80, projection parts 22p1, 32p are respectively formed on the outer surface 22a of the battery case 20 and the opposed surface 32b1 of the flange part 32b, which is different from the above-described configuration of the negative electrode terminal assembly 90. These projection parts 22p1, 32p each is a ring-shaped projection formed to protrude toward the positive side gasket 42 and to surround the positive insertion hole 26 in a plane view. These projection parts 22p1, 32p surrounding the positive insertion hole 26 can interrupt the deformation of the positive side gasket 42 outward in the diameter direction, and thus it is possible to furthermore suitably suppress the liquid leakage caused by the degradated deformation of the positive side gasket 42.

(4) 4th Rough Surface Area

The 4th rough surface area R4 is a rough surface area formed on the positive electrode terminal member 30 at the inside of the battery case 20. Below, while referring to a configuration of the positive electrode terminal assembly 80 at the inside of the battery case 20, the 4th rough surface area R4 will be described.

At first, the positive electrode terminal member 30 in the present embodiment includes a current interrupt device 33 and a positive electrode current collector 36, in addition to the positive electrode external terminal 32 described above. The current interrupt device 33 is a conductive member that is connected to the positive electrode external terminal 32 inside the battery case 20. Then, the current interrupt device 33 includes a configuration that can block an electrically conductive passage when the internal pressure of the battery case 20 exceeds a predetermined pressure. On the other hand, the positive electrode current collector 36 is a conductive member that is configured to implement connection between the current interrupt device 33 and the electrode body 10. In the positive electrode terminal assembly 80 including the configuration as described above, an electrically conductive passage from the electrode body 10 to the outside of the battery case 20 via the positive electrode current collector 36, the current interrupt device 33, and the positive electrode external terminal 32 is formed (see FIG. 1). Then, the current interrupt device 33 is configured to operate when an abnormality (overcharge, or the like) is caused on the sealed battery 1 and a large amount of gas is generated, so as to block the above-described electrically conductive passage. By doing this, it is possible to construct the sealed battery 1 which can automatically stop charging and discharging at the abnormality generation time and whose safety property is higher.

Below, a particular structure of the current interrupt device 33 will be described. The current interrupt device 33 includes a sealing tab 34 and an inversion plate 35. As shown in FIG. 4, the sealing tab 34 includes a base part 34a that is connected to the positive electrode external terminal 32 inside the battery case 20. This base part 34a is a disk-shaped member including an opening part 34al (see FIG. 2). This base part 34a is arranged along the inner surface 22b of the sealing plate 22. In other words, the base part 34a of the sealing tab 34 on the positive electrode terminal assembly 80 in the present embodiment is “inside plate-shaped part” that is connected to the positive electrode external terminal 32 inside the battery case 20 and that extends along the inner surface 22b of the sealing plate 22. In addition, the sealing tab 34 includes a ring-shaped protruding part 34b that protrudes from an outer circumferential edge part of the base part 34a to a direction (downward in the height direction Z) of the electrode body 10. Next, the inversion plate 35 of the current interrupt device 33 is a disk-shaped member that is connected to the above-described ring-shaped protruding part 34b of the sealing tab 34 (see FIG. 2 and FIG. 4). In addition, at a central part of the inversion plate 35, a projecting part 35a protruding downward in the height direction Z is formed. This projecting part 35a of the inversion plate 35 is connected to the positive electrode current collector 36 (first positive electrode current collector 36a). Then, the inversion plate 35 is formed to make the thickness be smaller in comparison to the other metal members configuring the positive electrode terminal member 30. Thus, when the internal pressure of the battery case 20 rises to a value equal to or more than a predetermined value by generation of gas, the inversion plate 35 is deformed to the upward in the height direction Z so as to be spaced away from the positive electrode current collector 36. By doing this, the electrically conductive passage between the positive electrode current collector 36 and the current interrupt device 33 is interrupted, and thus it is possible to automatically stop the charge and discharge of the sealed battery 1 at the abnormality generation time.

Incidentally, the positive electrode current collector 36 includes a first positive electrode current collector 36a (see FIG. 4) that is connected to the inversion plate 35 of the current interrupt device 33, and includes a second positive electrode current collector 36b (see FIG. 1) that is connected to the positive electrode collector tab 12 of the electrode body 10. Incidentally, as shown in FIG. 2, the first positive electrode current collector 36a is provided with plural (7 in the drawing) opening parts. By doing this, it is possible to properly transmit the internal pressure of the battery case 20 to the inversion plate 35.

On the other hand, the positive side insulating member 40 inside the battery case 20 includes a positive side insulating plate 44 disposed between the sealing plate 22 and the base part 34a of the sealing tab 34 (inside plate-shaped part). As shown in FIG. 2 and FIG. 4, the positive side insulating plate 44 is a plate-shaped member configured to cover an upper surface of the sealing tabs 34. In addition, an opening part 44a formed in a circular shape is formed on the positive side insulating plate 44. Into this opening part 44a of the positive side insulating plate 44, the shaft part 32a of the positive electrode external terminal 32 is inserted. Then, the positive side insulating plate 44 is pressurized between the sealing tab 34 and the sealing plate 22. By doing this, the gap between the sealing plate 22, the positive electrode external terminal 32, the sealing tabs 34, and the positive side insulating plate 44 is closed, and thus it is possible to inhibit the liquid leakage of the electrolyte from the positive insertion hole 26.

In addition, the positive side insulating member 40 includes a current collector holder 46, in addition to the positive side gasket 42 and the positive side insulating plate 44. The current collector holder 46 is a long resin member that extends in the width direction X (see FIG. 2). As shown in FIG. 4, one end part 46a in the width direction X of the current collector holder 46 is disposed between the inversion plate 35 of the current interrupt device 33 and the first positive electrode current collector 36a. By doing this, it is possible to inhibit the inversion plate 35 and the first positive electrode current collector 36a from contacting with each other after the current interrupt device 33 is operated (inversion plate 35 is deformed). In addition, the other end part 46b (see FIG. 2) in the width direction X of the current collector holder 46 is disposed between the second positive electrode current collector 36b and the sealing plate 22. By doing this, it is possible to inhibit conduction between the electrode body 10 and the sealing plate 22 via the second positive electrode current collector 36b.

In addition, the positive side insulating member 40 in the present embodiment includes a current collector cover 48, too. This current collector cover 48 is a resin-made member that is configured to cover a part of the first positive electrode current collector 36a and a lower surface of the second positive electrode current collector 36b. By providing this current collector cover 48, it is possible to inhibit the positive electrode current collector 36 and the electrode body 10 from directly contact with each other, so as to inhibit formation of unexpected electrically conductive passage.

As described above, “inside plate-shaped part” of the positive electrode terminal assembly 80 in the present embodiment is the base part 34a of the sealing tabs 34. Then, regarding the sealed battery 1 in accordance with the present embodiment, the 4th rough surface area R4 is formed on each among an opposed surface 34a2 of this base part 34a and the inner surface 22b of the sealing plate 22. By doing this, a friction resistance between the sealing tab 34 and the positive side insulating plate 44 and a friction resistance between the sealing plate 22 and the positive side insulating plate 44 are increased, and thus it is possible to suitably regulate deformation of the positive side insulating plate 44 toward the outside in the diameter direction, so as to suppress the liquid leakage caused by the degradated deformation of the positive side insulating plate 44.

Incidentally, a suitable surface roughness and suitable size of the 4th rough surface area R4 are also similar to those of the 1st rough surface area R1 to 3rd rough surface area R3, and thus the overlapping explanation is omitted. In addition, similarly to the 1st rough surface area R1 to 3rd rough surface area R3, it is also enough for the 4th rough surface area R4 to be formed on at least one of metal members contacting with the insulating member. In other words, it might be sufficient that a surface on which the 4th rough surface area R4 is formed is any one among the inner surface 22b of the sealing plate 22 and the opposed surface 34a2 of the base part 34a. Even in that case, it is possible to sufficiently regulate the degradated deformation of the positive side insulating plate 44.

In addition, regarding the sealed battery 1 in accordance with the present embodiment, projection parts 22p2, 34p are formed on the inner surface 22b of the battery case 20 and the opposed surface 34a2 of the base part 34a. These projection parts 22p2, 34p are formed to protrude toward the positive side insulating plate 44 and to surround the positive insertion hole 26 in a plane view. By these projection parts 22p2, 34p, it is possible to interrupt the deformation of the positive side insulating plate 44 to the outward in the diameter direction, and thus it is possible to furthermore suitably suppress the liquid leakage caused by the degradated deformation of the positive side insulating plate 44.

As described above, regarding the sealed battery 1 in accordance with the present embodiment, the rough surface areas R1 to R4 are respectively formed on metal members (sealing plate 22, flange part 52b of the negative electrode external terminal 52, negative electrode current collector 54, flange part 32b of the positive electrode external terminal 32, and sealing tabs 34) contacting with the insulating members (negative side gasket 62, negative side insulating plate 64, positive side gasket 42, positive side insulating plate 44). By doing this, it is possible to regulate deformation of each insulating member to the outside in the diameter direction, so as to properly suppress the liquid leakage of the electrolyte caused by the degradated deformation of the insulating member.

### Another Embodiment

Above, one embodiment for the herein-disclosed technique has been explained. Incidentally, the above-described Embodiment 1 is to show an example of the sealed battery in which the herein-disclosed technique is applied, and this embodiment is not intended to restrict the herein-disclosed technique.

For example, the sealed battery 1 in accordance with Embodiment 1 includes 4 rough surface areas being the 1st rough surface area R1 to 4th rough surface area R4. However, it is sufficient for these rough surface areas that at least 1 of them is formed, and thus it is not required to form all of these rough surface areas. For example, only the rough surface areas (1st rough surface area, and 2nd rough surface area) on the negative electrode terminal assembly might be formed, or only the rough surface areas (3rd rough surface area, and 4th rough surface area) on the positive electrode terminal assembly might be formed. In addition, only the rough surface areas (1st rough surface area, and 3rd rough surface area) at the outside of the battery case might be formed, or only the rough surface areas (2nd rough surface area, and 4th rough surface area) at the inside of the battery case might be formed. Furthermore, only one of 4 rough surface areas might be formed. It is preferable, regarding the point at which the rough surface area is formed, to appropriately select a point at which the degradated deformation of the insulating member tends to be caused, in consideration of a configuration of the terminal structure, a material of the part, a temperature distribution at the use time, or the like.

In addition, regarding the sealed battery 1 in accordance with Embodiment 1, a current interrupt device 33 is provided to the positive electrode terminal assembly 80. However, the current interrupt device is not an element for restricting the herein-disclosed technique. In other words, the current interrupt device might be provided on the negative electrode terminal assembly, or might be provided on both of the positive electrode terminal assembly and the negative electrode terminal assembly. Furthermore, the herein-disclosed technique can be properly applied to a sealed battery in which the current interrupt device is not provided on the positive electrode terminal assembly nor the negative electrode terminal assembly.

In addition, as shown in FIG. 4, regarding the sealed battery 1 in accordance with Embodiment 1, the projection parts 22p1, 22p2, 32p, 34p surrounding the positive insertion hole 26 are formed on the positive electrode terminal assembly 80. However, the projection parts surrounding the terminal attachment hole are might be formed on the negative electrode terminal assembly, as it is not restricted to the projection parts surrounding the terminal attachment hole formed on the positive electrode terminal assembly. In other words, the projection parts surrounding the terminal attachment hole can be formed without particular restriction, if they are formed on a surface of the metal member (surface of the battery case, opposed surface of the terminal member) on which the rough surface area can be formed.

Additionally, regarding the sealed battery 1 in accordance with Embodiment 1, the positive electrode terminal assembly 80 and the negative electrode terminal assembly 90 are attached to the sealing plate 22 of the battery case 20. However, the object to which the terminal structure is attached is not restricted to the sealing plate. For example, each terminal structure might be attached to any one surface of the wall surfaces configuring the case body formed in a box-shape. However, when the operation efficiency is considered at the time of assembling the plural terminal members and the insulating member so as to construct a terminal structure, it is preferable that the terminal structure is formed on the sealing plate.

### Test Example

Below, a test example related to the present disclosure will be explained. Incidentally, a content of the test example described below is not intended to restrict the present disclosure.

1. Preparing Sample

### (Sample 1)

In the present test, as an object for the rough surface process, an aluminum plate, thickness 2 mm×width 20 mm×depth 20 mm, was prepared. Then, on sample 1, the roughening process with a laser processing was performed so as to form the rough surface area on a surface of the aluminum plate. In particular, a laser irradiation apparatus (3-Axis fiber laser marker made by KEYENCE corporation, model: MD-F 3200) was used to irradiate pulse laser on the surface of the aluminum plate so as to form the rough surface area whose size was 5 mm×5 mm. Incidentally, regarding the roughening process for the sample 1, an output of the laser was 30 W, a scanning speed was 100 mm/sec, and a pulse energy was 5 J/pulse.

### (Sample 2)

On sample 2, an unprocessed aluminum plate was used on which the roughening process with the laser irradiation was not performed.

2. Evaluation Test

### (I) Measuring Surface Roughness

In the present test, regarding each sample after the roughening process, an arithmetic average roughness Sa and a maximum height Sz were measured. These measurements were performed with a contactless inspection device (model: VK-X130) made by KEYENCE corporation. Measurement results are shown in Table 1.

(2) Durability Test A disk-shaped insulating member (diameter: about 5.7 mm, thickness: about 0.4 mm) made from PFA resin was prepared and then arranged on the sealing plate (made of aluminum) of the sealed battery. Then, the aluminum plates of the samples 1 and 2 were overlaid on the insulating member and then were held in a state of being pressurized at 300 N pressure. Incidentally, regarding the sample 1, an aluminum plate was arranged so as to make the surface, on which the roughening process was performed, directly contact with the insulating member. Then, the resultant was arranged under a 60° C. environment while keeping the pressurized state, so as to perform the durability test of storing for 150 hours. Then, after 150 hours passed, the storing temperature was risen to be 100° C. and then further 15 hours storage was performed. Then, in the present test, a diameter of the insulating member was measured at each time point among before pressurizing, after pressurizing, 1 hour later, 25 hours later, 50 hours later, 100 hours later, 150 hours later, and 165 hours later since the storage. Measurement results are shown in Table 1.

TABLE 1

| | | Sample 1 | Sample 2 |
|---|---|---|---|
| Surface | Average roughness Sa | 1.93 | 0.89 |
| roughness | Maximum height Sz | 26.56 | 8.99 |
| (μm) | | | |
| Diameter | Before pressurizing | 5.789 | 5.792 |
| (mm) | Immediately after pressurizing | 5.933 | 5.969 |
| | 1 hour later since storage | 5.938 | 5.971 |
| | 25 hour later since storage | 5.943 | 5.995 |
| | 50 hour later since storage | 5.933 | 5.990 |
| | 100 hour later since storage | 5.924 | 5.988 |
| | 150 hour later since storage | 5.933 | 5.978 |
| | 165 hours later since storage | 5.938 | 5.985 |
| | (temperature risen to be 100° C.) | | |
| | After-pressurizing | 0.144 | 0.177 |
| | deformation amount | | |
| | After-heating | 0.005 | 0.017 |
| | deformation amount | | |

As shown in Table 1, regarding the sample 2, “after-heating deformation amount” representing a difference of a diameter at the time immediately after pressurizing and a diameter at the time 165 hours later since the storage of the insulating member was 0.017 mm. It can be understood that the increase in the diameter described above was caused by diameter expansion due to the pressure as the result of long period storage under a high temperature environment and then as the result of degradation of the insulating member reducing the rebound force. On the other hand, regarding the sample 1, the after-heating deformation amount was suppressed to be 0.005 mm. This can be understood that the roughening process increased the friction resistance between the aluminum plate and the insulating member so as to regulate diameter expansion of the insulating member. For a general sealed battery, in order to inhibit the liquid leakage of the electrolyte, it is required to control a manufacture tolerance of the insulating member (gasket, or the like) at a level equal to or less than 0.01 mm (preferably, equal to or less than 0.001 mm). In other words, in consideration of being able to suppress the deformation amount after exposed to a 100° C. high temperature environment to be about 0.005 mm, it was found that forming the rough surface area on the surface of the metal member contacting with the insulating member is very suitable as a technique of suppressing the liquid leakage of the electrolyte.

In addition, as shown by “after-pressurizing deformation amount” in Table 1, it was found regarding the sample 1 that the diameter expansion of the insulating member caused by the pressurizing process can be regulated. Even from the perspective as described above, it is understood that forming the rough surface area on the surface of the metal member contacting with the insulating member can be suitably used too much as the technique of suppressing the liquid leakage of the electrolyte.

Although the present disclosure is explained above in details, the above described explanation is merely an illustration. In other words, the herein-disclosed technique contains ones in which the above described specific examples are deformed or changed.

1. A sealed battery, comprising:
a battery case that comprises a terminal attachment hole and is configured to accommodate an electrode body;
a terminal member that is attached to the terminal attachment hole and comprises an opposed surface opposed to a surface of the battery case at a periphery of the terminal attachment hole; and
an insulating member that is made of resin and is disposed between the battery case and the terminal member, wherein
the surface of the battery case and/or the opposed surface of the terminal member comprises a rough surface area on at least a part of a portion contacting with the insulating member, and
an arithmetic average roughness Sa of the rough surface area is equal to or more than 1 μm.

2. The sealed battery according to claim 1, wherein
the terminal member comprises an outside terminal part comprising:
a shaft part that is inserted into the terminal attachment hole; and
a flange part that is formed in a plate shape and extends from the shaft part along an outer surface of the battery case at an outside of the battery case,
the insulating member comprises a gasket that is disposed between the outer surface of the battery case and an opposed surface of the flange part, and
the outer surface of the battery case and/or the opposed surface of the flange part comprises the rough surface area on at least a part of a portion contacting with the gasket.

3. The sealed battery according to claim 2, wherein
the terminal member further comprises an inside plate-shaped part connected to the outside terminal part inside the battery case and extending along an inner surface of the battery case,
the insulating member comprises an insulating plate disposed between the inner surface of the battery case and an opposed surface of the inside plate-shaped part, and
the inner surface of the battery case and/or the opposed surface of the inside plate-shaped part comprises the rough surface area on at least a part of a portion contacting with the insulating plate.

4. The sealed battery according to claim 3, wherein
the inside plate-shaped part is a long plate-shaped member arranged along the inner surface of the battery case and is a plate-shaped electrical collector part whose one end part is connected to the outside terminal part and whose another end part is connected to the electrode body.

5. The sealed battery according to claim 3, wherein
the terminal member comprises:
a current interrupt device that is connected to the outside terminal part inside the battery case and is configured to interrupt an electrically conductive passage when an internal pressure of the battery case exceeds a predetermined pressure; and
an electrical collector part that is connected between the current interrupt device and the electrode body,
the current interrupt device comprises:
a sealing tab comprising:
a base part that is connected to the outside terminal part inside the battery case and is arranged along the inner surface of the battery case; and
a ring-shaped protruding part that protrudes from the base part to the electrode body; and
an inversion plate that is connected to the protruding part of the sealing tab, is connected to the electrical collector part, and is configured to be deformed and spaced away from the electrical collector part when an internal pressure of the battery case rises to a value equal to or more than a predetermined value, and
the inside plate-shaped part is the base part of the sealing tab.

6. The sealed battery according to claim 1, wherein
the terminal member comprises:
an outside terminal part whose one part is exposed to an outside of the battery case; and
an inside plate-shaped part that is connected to the outside terminal part inside the battery case and extends along an inner surface of the battery case,
the insulating member comprises an insulating plate disposed between the inner surface of the battery case and an opposed surface of the inside plate-shaped part, and
the inner surface of the battery case and/or the opposed surface of the inside plate-shaped part comprises the rough surface area on at least a part of a portion contacting with the insulating plate.

7. The sealed battery according to claim 1, wherein
a projection part protruding toward the insulating member and surrounding the terminal attachment hole in a plane view is formed on the surface of the battery case and/or the opposed surface of the terminal member.

8. The sealed battery according to claim 1, wherein
the surface of the battery case and/or the opposed surface of the terminal member comprises the rough surface area on a part equal to or more than 5% of the portion contacting with the insulating member.

9. The sealed battery according to claim 1, wherein
the arithmetic average roughness Sa of the rough surface area is equal to or less than 100 μm.
